(19) United States
(12) Patent Application Publication
(10) Pub. No.: US 2018/0262991 A1
(43) Pub. Date: Sep. 13, 2018

(54) OPTIMIZATION OF ENERGY MANAGEMENT OF MOBILE DEVICES BASED ON SPECIFIC USER AND DEVICE METRICS UPLOADED TO CLOUD

(71) Applicant: Futurewei Technologies, Inc., Plano, TX (US)

(72) Inventors: Karthik Rao, Atlanta, GA (US); Jun Wang, Santa Clara, CA (US); Handong Ye, Sunnyvale, CA (US)

(73) Assignee: Futurewei Technologies, Inc., Plano, TX (US)

(21) Appl. No.: 15/456,186

(22) Filed: Mar. 10, 2017

(51) Int. Cl. H04W 52/02; H04L 29/08; G06F 1/26

(52) U.S. Cl. CPC H04W 52/0261; H04W 52/0222; G06F 1/263; G06F 1/266; H04L 67/22

(57) ABSTRACT

Data indicative of resource usage patterns (RUP's), application usage patterns (AUP's), power consumption and application performance is automatically and repeatedly collected from individualized mobile devices, aggregated into a cloud based database and sorted into categories according to device hardware type, device software type and user type. Optimized power management policies for the sorted classes of device hardware types, device software types and user types are developed in the cloud and downloaded into individualized ones of the mobile devices fitting into the respective classes.

### BACKGROUND

Battery life of mobile devices can vary due to numerous factors. It is desirable to maximize the operating time of mobile devices so that users do not have to recharge or change batteries too often.

### BRIEF SUMMARY

In an embodiment, a method is carried out in a mobile device for enabling and obtaining device specific refinement or replacement of power management policies of the mobile device. The method comprises: automatically and repeatedly uploading from the mobile device to a remote service, an identification of the mobile device and at least two of: data indicative of a respective applications usage pattern (AUP) of the mobile device, data indicative of a respective resources usage pattern (RUP) of the mobile device, data indicative of energy and/or power consumption by the mobile device due to at least one of the AUP and the RUP represented by the respectively uploaded and representative data of the AUP and the RUP or data indicative of a quality of service (QoS) provided by mobile device relative to the represented AUP and/or RUP; and receiving from the remote service a refinement to or replacement of the power management policies of the mobile device, the refinement or replacement being based at least on said automatically and repeatedly uploading from the mobile device to the remote service.

In a second embodiment that is in accordance with any of the preceding embodiments, the refinement or replacement is not based on just the uploading from the one mobile device but also on crowdsourced uploading from similarly situated other mobile devices such that data sampled from a number of similarly situated devices is used to develop statistically significant metrics with respect to power consumption, battery life, application usage patterns and quality of service performance for respective makes, models and versions of mobile devices. More specifically, in a second embodiment that is in accordance with the above first embodiment, the received refinement or replacement is based also on automatic and repeated uploadings by similarly situated other mobile devices to the data collecting and analyzing entity, the first said mobile device and similarly situated other mobile devices defining a sourcing crowd for the automatic and repeated uploadings.

In a third embodiment that is in accordance with any of the preceding embodiments, the remote service is at least partially provided by in-cloud resources of a Software as Service (SaaS) provider.

In a fourth embodiment that is in accordance any of the preceding embodiments, the identification of the mobile device includes at least one of: an International Mobile Equipment Identity (IMEI) number of the mobile device; an identification of a manufacturer of the mobile device; an identification of a model line to which the mobile device belongs; an identification of a version number of the mobile device; an identification of an operating system of the mobile device; an identification of hardware resources within the mobile device; an identification of firmware resources within the mobile device; or an identification of software resources within or immediately accessible by the mobile device.

In a fifth embodiment that is in accordance with any of the preceding embodiments, the applications usage pattern (AUP) of the mobile device includes at least one of: an identification of one or more applications being currently used as foreground executables of the mobile device; an identification of a predetermined number N of most favored applications used by the mobile device over a pre-specified recent period of time, each of the applications being identified by at least one of title, vendor number, serial number and a group or class of applications to which it belongs; an identification of an average level of sophistication employed when executing one or more of the identified N most favored applications; an indication of an average amount of time spent by the mobile device in executing one or more of the identified N most favored applications; an indication of a respective minimum quality of service acceptable when executing a respective one or more of the identified N most favored applications; an identification of most likely respective locations and/or respective other contexts when executing a respective one or more of the identified N most favored applications; or a ranked ordering of the identified N most favored applications based on at least one of: average time the respective application or a subgroup to which it belongs is used, urgency of having the respective application usable even when battery power is low, urgency of having the respective application usable in a pre-specified location and/or other pre-specified context.

In a sixth embodiment that is in accordance any of the preceding embodiments, the resources usage pattern (RUP) of the mobile device includes at least one of: an identification of one or more hardware and/or firmware resources being currently used within the mobile device; an identification of a predetermined number N of most favored resources used by the mobile device over a pre-specified recent period of time, each of the resources being identified by at least one of type, vendor number, serial number and a group or class of resources to which it belongs; an identification of an average level of power drawn or frequency and voltage employed when utilizing one or more of the identified N most favored resources; an indication of an average amount of time spent by the mobile device in utilizing one or more of the identified N most favored resources; an identification of most likely respective locations and/or respective other contexts when utilizing a respective one or more of the identified N most favored resources; or a ranked ordering of the identified N most favored resources based on at least one of: average time the respective resource or a subgroup to which it belongs is used, power or energy consumed by the respective resource or by a subgroup to which it belongs, urgency of having the respective resource usable in a pre-specified location and/or other pre-specified context.

In a seventh embodiment that is in accordance with any of the preceding embodiments, the indicated quality of service (QoS) relates to at least one of: a level of service provided by one or more of currently executing applications of the mobile device; a level of service provided by a pre-specified number N of most favored applications used by the mobile device over a pre-specified recent period of time; a level of service provided by one or more of currently utilized hardware and/or firmware resources of the mobile device; or a level of service provided by a pre-specified number N of most favored resources used by the mobile device over a pre-specified recent period of time.

In an eighth embodiment that is in accordance with any of the preceding embodiments, the receiving of a refinement to or replacement of a power management policy of the mobile device comprises: receiving of a refinement to or replacement of a power management policy for one or more governors of the mobile device.

In a ninth embodiment that is in accordance any of the preceding embodiments, the receiving of a refinement to or replacement of a power management policy of the mobile device comprises: receiving of a refinement to or replacement of a power management policy for a CPU cache tuning controller of the mobile device.

In a tenth embodiment that is in accordance any of the preceding embodiments, the receiving of a refinement to or replacement of a power management policy of the mobile device comprises: receiving of a refinement to or replacement of a power management policy for a dynamic usage controller of a pre-specified hardware or firmware resource of the mobile device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system for tracking power consumption performance by specific mobile devices as used by specific users and updating their power management subsystems to optimize battery life according to specific usage patterns in accordance with various embodiments.

FIG. 2A is a schematic illustrating how a given specific user can have predictable usage patterns in accordance with various embodiments.

FIG. 2B is a schematic illustrating how crowd sourcing may be used to gather statistically significant usage data for providing quicker updates in accordance with various embodiments.

FIG. 3A is a flow chart depicting a first performance tracking and optimizing method in accordance with various embodiments.

FIG. 3B is a flow chart depicting a second performance tracking and optimizing method in accordance with various embodiments.

FIG. 4 is a flow chart depicting a data uploading and policy generating method for a data collecting and analyzing entity in accordance with various embodiments.

FIG. 5 is a flow chart depicting an analysis carried out by the data collecting and analyzing entity in accordance with various embodiments.

FIG. 6 is a block diagram depicting three types of operatively interconnected engines of a system in accordance with the present disclosure in accordance with various embodiments.

### DETAILED DESCRIPTION

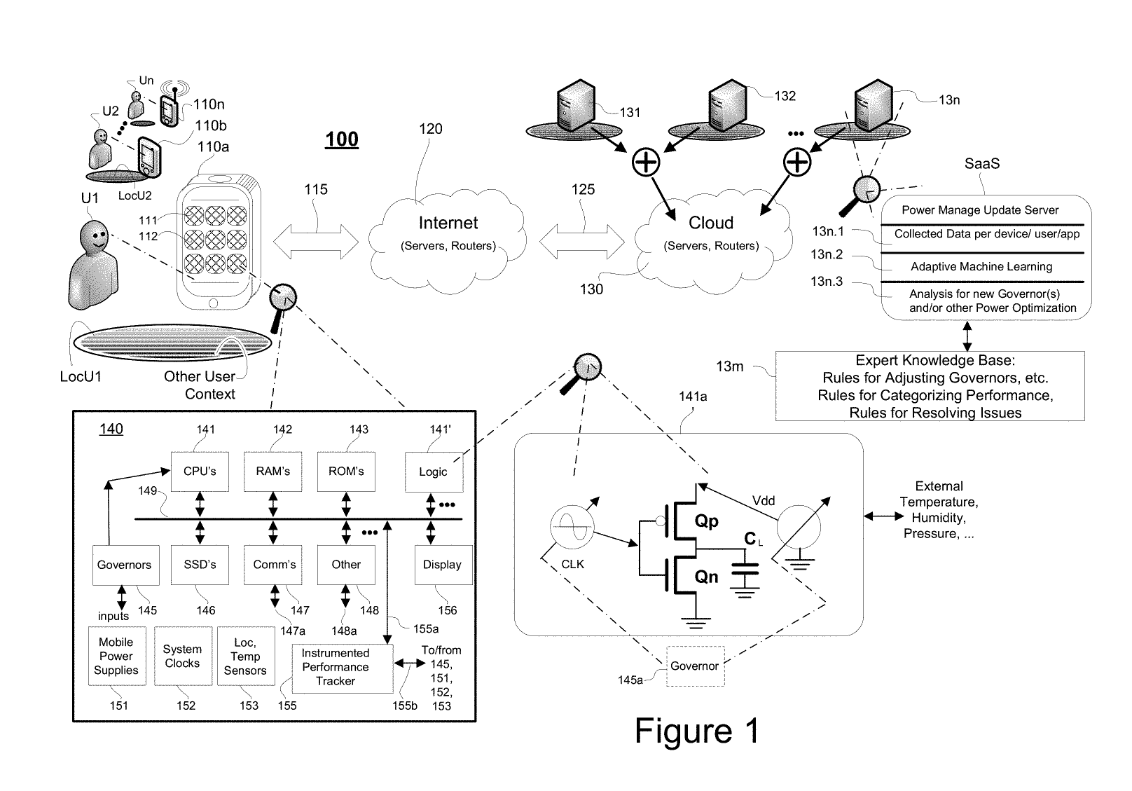

FIG. 1 is a block diagram of a system 100 configured for tracking power consumption performance by specific mobile devices 110a, 110b, 110n and by their respective users U1, U2, Un and updating their respective power management subsystems (e.g., governors 145) to optimize battery life based on the tracking in accordance with the present disclosure.

More specifically, FIG. 1 shows an integrated client-server/internet/cloud system 100 (or more generically, an integrated multi-device system 100) having battery-powered mobile client devices (e.g., smartphones 110a, 110b, 110n) and to which the here disclosed technology may be applied. System 100 may also be referred to as an Software as a Service (SaaS) serviced, distributed resources, machine system in which there are provided a variety of differently-located data processing and data communication mechanisms including for example, customer-sited units (e.g., wireless smartphones, tablets, laptops and the like denoted as 110a-110n or generally as 110) configured to allow end-users thereof (e.g., U1) to request from respective end-user occupied locations (e.g., LocU1) services from differently located service hosts (e.g., in-cloud servers 131, 132, . . . 13n) which may be generally thought of as being in the cloud 130.

It is to be understood that the configuration of the illustrated system 100 is merely exemplary and that management of power consumption by specific user devices in accordance with the present disclosure may be carried out from locations other than the indicated cloud 130. As will be understood from FIG. 1, the system 100 comprises at least a few, but more typically a very large number (e.g., thousands) of end-user devices 110a, . . . , 110n (only a few shown in the form of wireless smartphones but understood to represent many similarly situated mobile and/or stationary client machines—including the smartphone wireless client kinds and cable-connected desktop kinds). These end-user devices, collectively denoted here as 110 come in many forms including different brands (e.g., Apple™, Android™, etc.), different versions (e.g., 2015, 2016, 2017, etc.), different sizes and different internal resources where the latter resources can include different CPU's, different operating systems, different software applications, different communication capabilities and so on. In other words, each user may posses a specific mobile or other battery powered data processing device that is custom tailored for that user (e.g., at least due to specific applications installed and run by that user). While the below description generally describes a specific battery powered data processing device (e.g., mobile device) as being continuously under the control of a single user, it is within the contemplation of the present disclosure to apply similar tracking and power management adjustment to specific battery powered data processing devices (e.g., mobile devices) that are controlled by a specific group of persons where the group can have specific usage patterns. For example, a classroom laptop computer may be shared by a group of students and the usage pattern may vary depending on whether it is a fifth grade history class or a doctoral level engineering class.

The various end-user devices 110 include one or more specific applications (“apps”) that are each capable of originating and transmitting service requests which are ultimately forwarded to service-providing host machines (e.g., in-cloud servers 131, 132, . . . 13n) within the cloud environment 130. Results from the service-providing host machines are thereafter typically returned to the end-user devices 110 where some of the results are displayed and/or otherwise communicated (e.g., by audio means) to the end-users (e.g., U1, U2, Un). Transmitting a request generally consumes power (typically from the battery of the mobile device). Displaying and/or audio outputting of results (e.g., streaming video movies or live action games) also generally consumes power. Thus power consumption can be a function of the specific usage pattern of the respective user of each specific client device.

Each of the various end-users may have a different pattern of usage on each specific client device due at least to that device having different applications installed in it and/or that device having device specific input/output means (e.g., keypad, touchscreen, voice control, etc.). More specifically and as a first example, a first end-user (U1) may have installed on his/her smartphone (110a) a first software application (“app1”) that automatically repeatedly and often requests and downloads from the cloud, streaming audio-video entertainment which causes the first user's smartphone 110a to have its display constantly on, its speakers constantly playing music and its communication modules (e.g., 147) automatically repeatedly transmitting requests (e.g., cellular telephone mediated requests) for more streamed video feeds. During the times that this power demanding usage pattern is occurring, battery drainage will be relatively large. On the other hand, a second end-user (U2) may however, have installed on his/her smartphone (110b) a different application (app2) which does not task the local display, audio means and/or local communication modules with repeated power demanding jobs. Thus the demands on the mobile power supply of the second client device 110b may be less rigorous. Every user (U1, U2, Un) may have a respectively unique usage pattern that is followed on a per day habitual basis (or on a per context basis). Alternatively it is within the contemplation of the present disclosure to determine which of a learned set of categorized usage classes each user falls into. In accordance with one aspect of the present disclosure, information about application usage patterns (AUP's) is stored in metadata (data about other data) and uploaded to a central processing point for analysis.

Just as respective users can have specific application usage patterns (AUP's), specific applications or categorized classes of such applications may have respective resource utilization patterns (RUP's) within specific ones of the different mobile devices. The combination of the AUP's and the RUP's will typically impact the rate at which power is drawn from the mobile power source for providing a desired quality of service (QoS). In some cases, as detailed below, power supplies can be intelligently managed to reduce power draw, extend battery life and yet provide a reasonably acceptable QoS (e.g., reasonably acceptable to specific users, to specific groups or subgroups of users or to at least a majority of users). In accordance with one aspect of the present disclosure, information about resource utilization patterns (RUP's) is stored in metadata (data about other data) and uploaded to a central processing point for analysis (e.g., to one or more remote SaaS providers operating collaboratively as an example of a data collecting and analyzing entity and providing corresponding remote services).

While a variety of possibilities are listed above for collection and analysis of metadata respecting device categorization, application usage patterns (AUP's) and resource usage patterns (RUP's), in one embodiment the to-be-collected metadata is subdivided into primary or core metadata and secondary metadata where collection of the secondary metadata can be bypassed if communication and/or processing bandwidth is limited at times. The core metadata may consist for example of: the device International Mobile Equipment Identity (IMEI) and device model identification for identifying each device and its hardware category; the current OS version for identifying each device according to a respective supervisory software category; the ID and version number of the currently running application for identifying each device according to its respective application software category; the core resource usage pattern (RUP) in terms of CPU frequency, memory bandwidth and GPU frequency for identifying each device according to its respective current resources configuration and the current power consumption by each of the core resources (e.g., CPU, memory, GPU). Other factors (e.g., temperature, humidity, location etc.) may be considered as secondary.

Aside from the above-mentioned end-user devices (e.g., 110) and the in-cloud servers (e.g., 131, 132, . . . , 13n), the system 100 generally comprises: one or more wired and/or wireless communication networks 115 (only one shown in the form of a wireless bidirectional interconnect) coupling the end-user client(s) 110 to networked servers 120 (not explicitly shown, and can be part of an Intranet or the Internet) where the latter may operatively couple by way of further wired and/or wireless communication networks 125 (not explicitly shown) to further networked servers (e.g., 131, 132, . . . 13n) disposed in the cloud 130.

The second set of networked servers 130 is depicted as the “cloud” 130 for the purpose of indicating a nebulous and constantly shifting, evolving set of hardware, firmware and software resources. In-the-cloud resources are typically used by large scale enterprise operations for the purpose of keeping mission critical tasks going without undue interruptions. As those skilled in the art of cloud computing appreciate, the “cloud” 130 may be implemented as reconfigurable virtual servers and virtual software modules implemented across a relatively seamless web of physical servers, storage units (including flash BIOS units and optical and/or magnetic and/or solid state storage units), communication units and the like such that point failure of specific units within the physical layer are overcome by shifting the supported virtual resources to spare other support areas in the physical layer. Because of sheer size and also the constantly shifting and self-reconfiguring fabric of resources, it can be very difficult to monitor and manage all the hardware and software resources of the system 100. The latter task is often delegated to an SaaS (software as a service) provider having in-cloud resources and an ability to track performance parameters of various system components including self-reported parameters of the end-user devices 110. More generally, the SaaS provider may be considered here as an example of a relatively centralized data collecting and analyzing entity that provides corresponding remote services although specific resources of that data collecting and analyzing entity need not themselves be centrally located and instead may be distributed over a network and/or implemented in a cloud. It is within the contemplation of the present disclosure that a plurality of SaaS providers may join to collaboratively provide the data collection and analysis operations disclosed herein, where the collaborative plurality thereby becomes a data collecting and analyzing entity for purposes of the disclosure. SaaS collection of data from individual ones or pluralities of similarly situated mobile devices over time allows for building of database whose records may be used to discover correlations between device make and/or model and application usage patterns (AUP's) and/or resource usage patterns (RUP's) and corresponding energy consumption minimizing policies while still providing user-acceptable quality of service (QoS). A system in accordance with various embodiments the present disclosure may comprise: automated upload means installed in the one or more mobile devices and configured to automatically repeatedly upload to a remote service: data indicative of the identification of the device; data indicative of current application usage patterns (AUP's) by the device; data indicative of current resource usage patterns (RUP's) in the device; data indicative of current energy or power consumption by the device and data indicative of a difference between current quality of service and a user-acceptable quality of service (QoS). The SaaS collected data is stored in a database and then automatically repeatedly analyzed by analyzer means to identify similarly situated mobile devices, and corresponding energy consumption minimizing policies that provide user-acceptable quality of service (QoS) in light of current AUP's, RUP's and/or other contextual aspects of the current operating mode of each mobile device. The SaaS provider provides automated download means for downloading to the remote mobile devices, respective energy consumption minimizing policies that provide user-acceptable quality of service (QoS) in light of current AUP's, RUP's and/or other contextual aspects of the current operating mode of each mobile device. An advantage of such a system is that data collection can occur in the background and can adaptively change to meet changing application usage patterns. An advantage of crowd sourcing version of such a system is that data can be collected more quickly from a crowd of similarly situated mobile devices and download of more optimized, energy consumption minimizing policies can occur all the faster.

Still referring to FIG. 1, a quick walk through is provided here so that readers may appreciate the bird's eye lay of the land, so to speak. Item 111 represents a first installed and user-activatable software application (first mobile app) that may be launched from within the exemplary mobile client 110a (e.g., a smartphone, but could instead be a tablet, a laptop, a wearable computing device; i.e. smartwatch or other). Item 112 represents a second such user-activatable software application (second mobile app) and generally there are many more. Each end-user installed application (e.g., 111, 112, . . . ) can come in the form of nontransiently recorded digital code (i.e. object code or source code) that is defined and stored in a memory for instructing a target class of data processing units to perform in accordance with end-user-side defined application programs (‘mobile apps’ for short) as well as to cooperate with server side applications implemented on the other side of communications links 115 and/or 125. Each app (e.g., 111, 112) may come from a different business or other enterprise and may require the assistance of various and different online resources (e.g., Internet, Intranet and/or cloud computing resources) to perform its tasks. Generally, each enterprise is responsible for maintaining in good operating order its portions of the distributed system (e.g., Internet, Intranet and/or cloud computing resources) so that end users experience satisfactory qualities of service (QoS's). For sake of simplicity it is assumed here that one SaaS provider (an example of a data collecting and analyzing entity) has been designated to manage all of the online resources including power management aspects of all or a majority of the end user devices 110. In the more practical world, plural business or other enterprises can pool parts of their resources into a common core of resources that are watched over by a single SaaS provider so as to reduce operating costs. In accordance with one aspect of the present disclosure, suppliers of a variety of different mobile user devices 110 task a single SaaS provider to handle battery life optimization for their respective devices 110.

As already hinted at above, power consumption in the various end user devices 110 (e.g., specific brands) may be a function of many variables other than just which apps are currently installed and most often used by the respective users as their favorite apps. Location (including local temperature conditions, air pressure, humidity, etc.) and interference-free availability of various communication means are other factors. More specifically, one user's smartphone (e.g., 110a) may rely mostly on a cellular telephony service providing portion of communications network 115 and may generally operate in warm locations so that internal semiconductor components (e.g., Qn, Qp) tend to run relatively hot. Another user's smartphone (e.g., 110b) may rely mostly on WiFi™ or BlueTooth™ and may generally operate in colder locations so that internal semiconductor components (e.g., Qn, Qp) tend to run much cooler. It may be beneficial for the power managing SaaS provider (not specifically shown, understood to have an in-cloud server such as 13n) to know about these operating conditions of the respective end users and/or their devices 110 (e.g., specific brands) and to custom tailor how power management is operated in their devices when used with different favorite apps, different device brands and/or versions, at different end-user locations (e.g., LocU1, LocU2) when subjected to respective different temperatures, humidities, and/or operated using different communication resources (e.g., cellular, WiFi™, other), and under different communication interference conditions, so that each end-user has a satisfactory battery life experience despite the use of the different apps in different specific hardware platforms and/or as supported by different specific firmware platforms while subject to different environments and/or under different conditions.

In one embodiment, at least a subset of the mobile devices 110 (e.g., devices of respective users who agree to have their usages monitored) are instrumented so that in the background the mobile devices automatically repeatedly provide useful power-consumption related data and performance related data (e.g., QoS) for example as metadata that can be picked up by the SaaS provider (e.g., server 13n) for monitoring of power consumption and performance of their respective user devices under different circumstances, where pickup of the related data may occur with respect to different favorite apps, different device brands and/or versions, operated for example at different locations (e.g., LocX1, LocX2, LocXn) having representative temperature conditions and/or representative communications capability conditions.

Instrumentation may vary from one user device (e.g., 110a) to the next (e.g., 110b). Some may have built-in power measuring sensors (not shown—could be part of 153) that directly measure how much power is being drawn from the mobile device battery system at different times and under different conditions. Generally, this is not the case. However, the amount of power drawn by a specific client device may be inferred from a number of proxy factors, for example current clock frequency (CLK) and current DC voltage (Vdd) supplied to digital logic circuits (e.g., 141a′). An example of a partly instrumented mobile device is depicted within magnification 140. The instrumented mobile device may have a respective local operating system (e.g., Apple iOS™ or Android™) and may include API's (Application Programming Interfaces) to various local apps (e.g., 111, 112, . . . ). It may further include instrumented execution code where the instrumented part causes various pieces of metadata to be automatically embedded in the back and forth communication packets of the device 140 that get relayed to and from the SaaS server 13n. Examples of such embedded metadata may include indications of time (time stamps), current power consumption levels, currently running foreground applications, current location, current temperature, current end user ID, type of local OS, ID of currently used cellular carrier or WiFi™ service and so forth. This embedded metadata is uploaded and picked up by backend SaaS server(s) and is used in accordance with the present disclosure for determining power consumption and performance of mobile devices 110n under different operating conditions. The uploaded metadata can also provide information about the application usage patterns (AUP's) of each respective user and about the resource usage patterns (AUP's) of each respective and specific client device.

Mobile apps (e.g., 111, 112), mobile operating systems (OS's), end-user devices (e.g., 110a, 110b, . . . ) and communication modalities (e.g., 115) are constantly changing. Because of this, SaaS providers (e.g., 13n) may need to constantly update the way they handle installed power management agents (e.g., governor 145) for in-field and newly introduced mobile devices. The present disclosure provides methods and systems for doing so.

Internal resources of end user devices (e.g., 110a, 110b, . . . ) are typically subdivided into sections with different responsibilities and/or capabilities. Internal magnification 140 of exemplary device 110a is used here as an example of device sections. The latter sections may include a limited number of intercoupled, “local” resources such as one or more local data processing units (e.g., CPU's 141), one or more local data storage units (e.g., RAM's 142, ROM's 143, Disks 146 e.g. SSD's), one or more local data communication units (e.g., COMM units 147), and a local backbone (e.g., local bus 149) that operatively couples them together as well as optionally coupling them to yet further ones of local resources 148. The other local resources may include, but are not limited to, specialized or general purpose sensors 153 including those (e.g., GPS) for automatically determining device location, local temperature(s), local time, altitude, etc. Other sensors may include one or more cameras, microphones, radiation detectors (e.g., RF energy), etc. There may be light or other signal sources for flash photography, night vision, etc. There may further be included specialized high speed graphics processing units (GPU's, not shown), specialized high speed digital signal processing units (DSPU's, not shown), custom programmable logic units (e.g., FPGA's, not shown), analog-to-digital interface units (A/D/A units, not shown), parallel data processing units (e.g., SIMD's, MIMD's, not shown), local user interface displays (e.g., 156) and so on.

It is to be understood that various ones of the merely exemplary and illustrated, “local” end-user resource sections (e.g., 141-148, 156, etc.) may include or may be differentiated into more refined kinds. For example, the local CPU's (only one shown as 141) may include single core, multicore and integrated-with-GPU kinds. The local storage units (e.g., 142, 143, 146) may include high speed SRAM, DRAM kinds as well as configured for reprogrammable, nonvolatile solid state data storage (SSD) and/or magnetic and/or other phase change kinds. The local communication-implementing units (only one shown as 147) may operatively couple to various external data communicating links such as serial, parallel, optical, wired or wireless kinds typically operating in accordance with various ones of predetermined communication protocols (e.g., internet transfer protocols, TCP/IP; WiFi™; Bluetooth™). Similarly, the other local resources (only one shown as 148) may operatively couple to various external electromagnetic or other linkages 148a and typically operate in accordance with various ones of predetermined operating protocols. Additionally, various kinds of local software and/or firmware may be operatively installed in one or more of the local storage units (e.g., 142, 143, 146) for execution by the local data processing units (e.g., 141) and for operative interaction with one another. The various kinds of local software and/or firmware may include different operating systems (OS's), various security features (e.g., firewalls), different networking programs (e.g., web browsers), different application programs (e.g., word processing, emailing, telephony, spreadsheet, databases, multimedia entertainment, etc.) and so on.

Included within the local device resources is at least one instrumented performance tracker 155 which is operatively coupled to various ones of the other resources (e.g., by way of link 155a to the backbone 149 and/or by way of link 155b to specific resources such as 145, 151, 152, 153) such that the performance tracker 155 can forward useful performance indicating data to the SaaS provider 13n for analysis and reaction. In accordance with the present disclosure, the included performance tracker 155 allows a remotely located SaaS analyzer (e.g., 13n) to spot emerging problems (e.g., those related to power management and battery life) and to try to mitigate such problems and/or improve performance without having to be physically present at the location (e.g., LocU1, LocU2, LocUn) of every user. In one embodiment, an automated, artificial intelligence analyzer 13m which relies for example on an expert ruled knowledge database, uses over-time developed rules (e.g., heuristically developed rules) for resolving different issues within the monitored system 100 including that of adjusting power control within the specific client devices (110a, 110b, 110n) based on the specific application usage patterns (AUP's) and specific resource usage patterns (RUP's) of the individual users and their respective specific client devices. While this proposition is being stated in the positive, namely, determining what the AUP's and RUP's are in specific contexts (e.g., favored apps used at specific times and/or in specific places); it is to be understood that power saving can come from a slightly modified negative of that proposition, namely, determining for respective contexts, which applications are not then favored (and should be put in sleep mode) and/or which device resources are not then needed (and should be put in sleep or shut off mode) and/or which high end performance qualities (e.g., QoS's) are not then required so as to thereby reduce power consumption based on the determined specific application usage patterns (AUP's) and specific resource usage patterns (RUP's) of the individual users and their respective specific client devices and favored apps used in respective different contexts. The unnecessary applications and/or device resources and/or which high end performance qualities can then be responsively placed into sleep or shut off modes based on determination of respective current contexts.

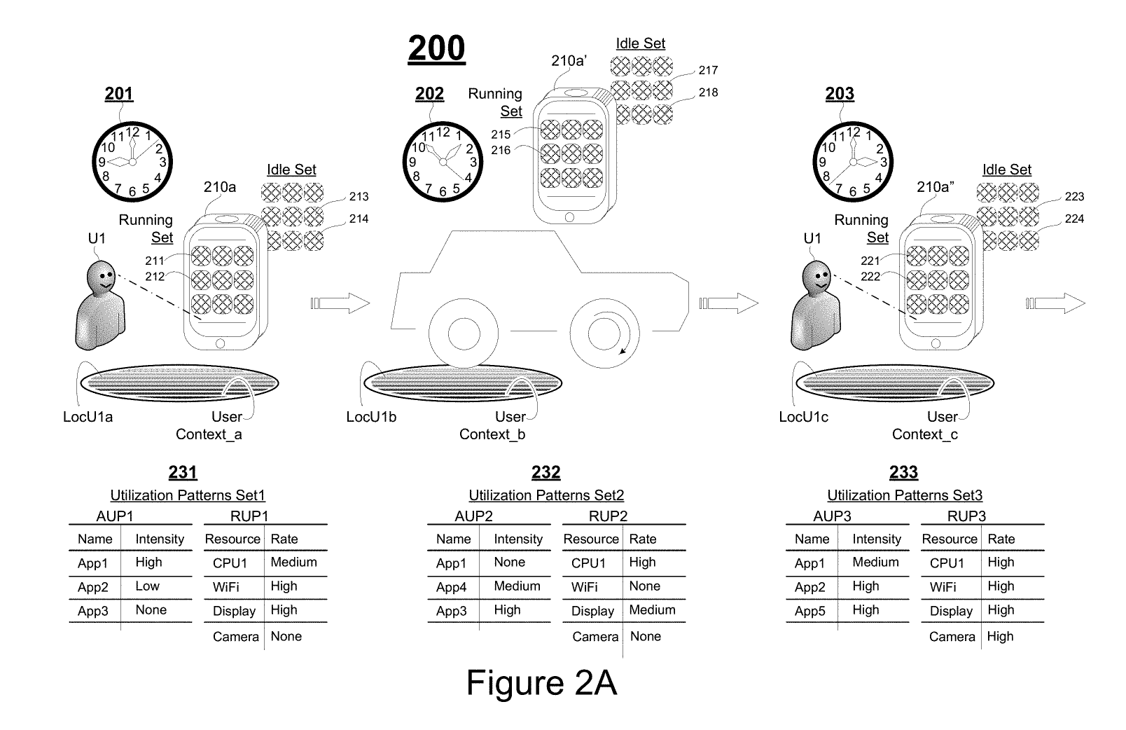

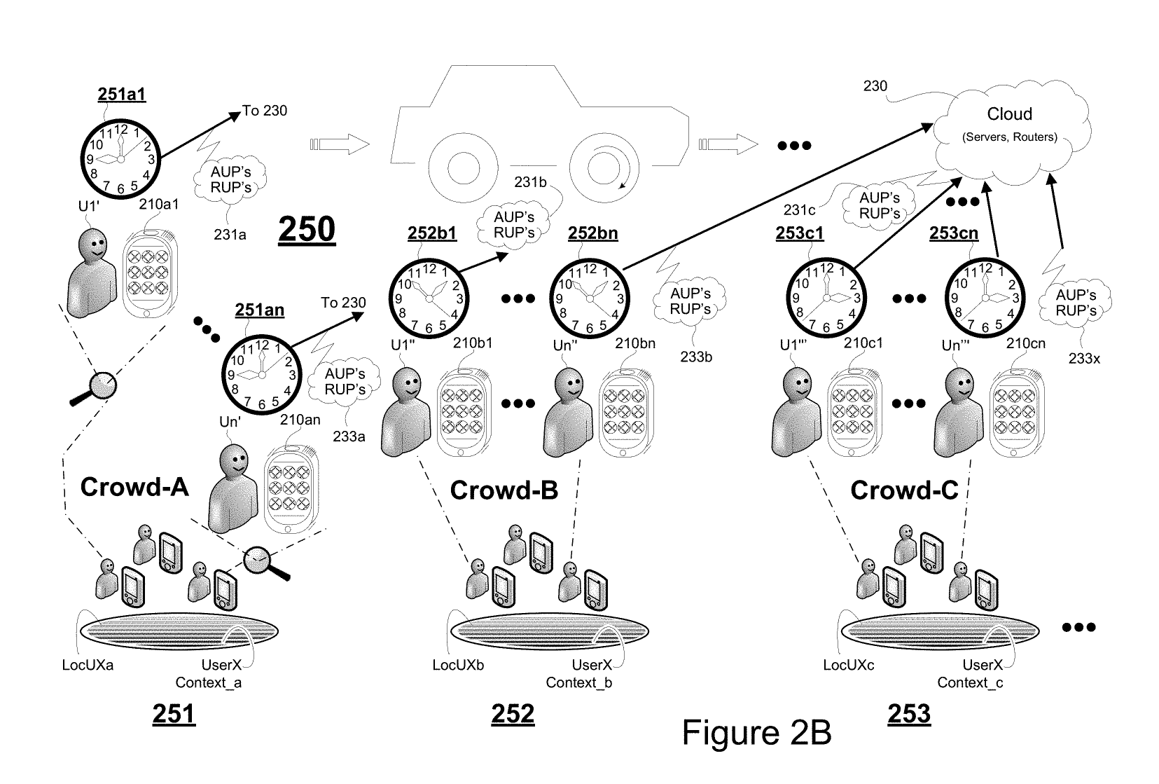

It is to be appreciated that monitoring of every end user device (110a, 110b, 110n) and at often repeated times for each such device is not necessary. In accordance with one aspect of the present disclosure, only a representative subset (e.g., 10%) of each predetermined class of end user devices and/or of representative users (e.g., U1, U10, U20, Un—not all shown) needs to report in on a random or time staggered round robin basis as to application usage patterns (AUP's) and resource usage patterns (RUP's) at different locations and/or different times of the day. In one embodiment, users of respective classes of devices are asked to volunteer to have user-chosen ones of their in-class devices participate in the usage monitoring and reporting process. The request for volunteers may explain to prospective volunteers that this is a crowd-sourced process where their participation contributes not only to their own benefit but to the greater good of all users who will be using the respective class of devices under different conditions including for example at different geographic locations, at different times of the day, under different weather conditions and/or under different other contexts. Ideally the volunteers are sufficiently distributed to provide statistically significant samples for the respective different conditions and/or combinations of such different conditions. Crowd sourced collection of data can result in shorter collection times and quicker updating as will explained below in conjunction with FIG. 2B. The SaaS provider (13n) accumulates the sparsely reported AUP and RUP usage pattern data of the representatives and combines it (aggregates it, stores it, categorizes it, adaptively converts it into machined-learned expert rules) so as to generate statistically representative data for the represented classes of end user devices 110 and/or represented classes of end users (U1, . . . , Un) under respective ones of identified different operating conditions. The sparse and distributed reporting process has several advantages. It does not consume much power from any one end user device. It does not add much to the bandwidth usage of any one communications pathway. If some communications pathways are down at the moment, representative data is nonetheless obtained by way of other, still functioning pathways. The entire population of represented end user devices 110 and represented end users may benefit from SaaS analysis of performance data gathered from the instrumented representative end user devices/users (e.g., 110a/U1) and from improved power management firmware and/or parameters that get downloaded and installed as a result of that performance data gathering and analysis.

One technique for determining and/or controlling local power consumption is called Dynamic Voltage and Frequency Scaling (DVFS). It is based on a modeling of a digital circuit's power consumption that says it is made up of two major components: (a) the dynamic power (P_{dyn}) consumed due to capacitive loading plus clock oscillation rate and (b) the static leakage of power (Pₗₑₐₖ) due for example to operating at elevated temperature and/or at elevated voltages. The sum may be represented as: Pₜₒₜₐₗ=P_{dyn}+Pₗₑₐₖ. The components may be represented as functions of applied voltage and currently utilized clock frequency as follows:

P_{dyn}=α●C_{L}●V²●f

Pₗₑₐₖ=V_{dd}●Iₗₑₐₖ

In the above, α (alpha) is an activity factor representing the circuit's dynamic switching activity (for example due to intense versus less intense usage of the circuitry by different applications). C_{L} is the circuit's load capacitance, V_{dd} is the applied DC voltage, f is the clock frequency and Iₗₑₐₖ is a current leakage current amount due to current temperature and/or the currently applied DC voltage Vdd. A representative circuit is shown at 141a of FIG. 1 where that representative circuit 141a is understood to be within digital logic circuit 141′ and digital logic circuit 141′ can be part of a local CPU 141 or part of another local digital logic circuit. The illustrated example depicts a CMOS circuit having a P-type first MOSFET Qp and an N-type second MOSFET Qn connected in series with Vdd applied from a variable DC source to Qp and a clock signal CLK applied to the joined gates of Qn and Qp in accordance with a given activity factor α. In one embodiment, an automated governor module 145a automatically determines what pair of Vdd and clock frequency f will be applied. This in turn can determine current power consumption for a given activity factor α and external factors such as temperature. Although one governor 145a is shown coupled to a respective one logic circuit 141a, it is to be understood that modern client devices can have a plurality of such governors each coupled to a different section of the client device (e.g., 110a) and each operating in accordance with its own power management rules or parameters. More specifically, each CPU (e.g., 141) or other such processors (e.g., GPU) may have its own respective governor and/or pre-specified groups of processors may share respective governors. Each memory unit (e.g., 142, 143, 146) may have its own respective governor and/or pre-specified groups of memory units may share respective governors. Each communications unit (e.g., 147) may have its own respective governor and/or pre-specified groups of communication units may share respective governors and so on. Each such governor may have its own set of inputs (“inputs” shown at 145) to which it reacts when switching for example from one (Vdd, f) configuration to a next one. By determining the current (Vdd, f) configurations of all the governors within a specific client device and also determining alpha activity factors and capacitive loadings (C_{L}) of all the in-use circuits, one can estimate by proxy what the total current power consumption of the device is. Alternatively or additionally, current power consumption on a per application basis may be determined by detecting how long respective governors of respectively used resources stay in one (Vdd, f) configuration and then switch to a next one based on automated governor policy rules established for that application. It can also be determined if a current, per application set of automated governor policy rules is optimum (in terms of energy consumption minimization) when analyzed in view of how the user typically uses that application (as opposed to how a so-called, “power user” might maximally stress that same application. In one embodiment, usage profiling data is collected to determine how each specific user or class of users actually use and stress each respective application, where the collected usage profiling data can then be used to create more optimal (in terms of energy consumption minimization) automated governor policy rules for the respective specific user or class of users. Respective policy rules for internal governors and/or other power managing controllers of the client device can be provided in accordance with various embodiments of the present disclosure as automatically repeated testings for predefined conditions and corresponding modifications to the settings of the respective internal governors and/or other power managing controllers of the client device based on detected conditions. In one embodiment, each policy rule may comprise a test for a trigger condition (e.g., hardware, firmware of software that implements an IF Trig1=true THEN Action1 ELSE . . . contingent execution or branch operation) and performs corresponding controller modification action(s) when the trigger condition(s) are satisfied or branches to a next test of a closed and automatically repeated execution loop.

Power management is not limited to Dynamic Voltage and Frequency Scaling (DVFS). Above the basic digital logic circuit level, there are various micro-architectural techniques that have been proposed to improve energy-efficiency such as: (a) CPU cache tuning (W. Zang et. al., A survey on cache tuning from a power/energy perspective, ACM Computing Survey, Vol. 45, No. 3, June 2013); (b) memory compression (L. Benini et. al., Hardware-assisted data compression for energy minimization in systems with embedded processors, Design, Automation, and Test in Europe, pp 449-453, 2002); and (c) use of asymmetric cores such as ARM's big.LITTLE architecture (www.arm.com/products/processors/technologies/biglittle-procesing.php). At the Operating System (OS) level due to the special role of the OS in controlling system behavior, there is a proliferation of energy-aware resource management techniques, many of which have been adopted by popular OS's such as Linux. DVFS, which was initially limited to only the CPU is now also available for managing GPU's, memory bandwidth, buses etc. As mentioned, each device may have a respective separate governor (e.g., 145a of FIG. 1) for each section which is designed to provide managed power performance of that section based on QoS and like demands. In some systems, a default-idling policy is implemented where, i.e. the component will go into a low-power idle state if it is not being used, thus conserving power.

These above noted techniques are of a general-purpose system type in that they are often designed to address the energy-efficiency of the mobile device as a whole without regard to specifics of what apps are being executed and/or in which geographic location and/or by what user (or type of user) under what contexts. Not only are they general purpose with respect to which applications are running, but they are also general purpose with respect to which version of which brand, size, type of mobile device is being used. It is possible that efficient management of power consumption from battery based power systems can be dependent on specific end use patterns and specific versions of specific brands of client devices. Hardware characteristics and/or usage characteristics of every user on every device will in most cases differ significantly. Furthermore, as each device ages, its performance may deteriorate in noticeable ways. A “one-size-fits-all” strategy to manage performance and battery life tends to be inefficient and may result in bad user experiences. In accordance with one aspect of the present disclosure, automatically repeated collection of data relevant to current power management is undertaken where the collected data includes that specific to the current user (e.g., what types of apps are being currently run by the user), the current location and its conditions (e.g., temperature, air pressure, communication options, etc.), specific to the mobile device (e.g., age, available speeds, display resolution) in order to achieve user acceptable performance while consuming less battery power.

More specifically, in accordance with the present disclosure, power consumption and performance tracking metadata pertaining to each specific mobile device (e.g., specific brand, version) is uploaded to the cloud (or to another form of data collecting, centralizing, and analysis entity) so as to enable adaptive learning within the cloud (e.g. within 13n.2 and 13m of FIG. 1) about specific application usage patterns, specific application runtime performances, hardware characteristics unique to each specific device or specific class of such devices, unique to each device operating environment (e.g., temperature, altitude, etc.) and so on. The adaptive in-cloud learning is then used to dynamically generate expert rules for generating power management policies that improve energy-efficiency of applications running in the specific machine brands and/or versions and/or differentiated classes of such while simultaneously maintaining a user-acceptable level of performance (e.g., QoS). Once again, although the proposition is being stated from the positive view point, namely, determining what are the AUP's and RUP's in specific contexts (e.g., specific brands, versions, favored apps, favored communication links, typical times and/or typical places); it is to be understood that power saving can come from a slightly modified negative of that proposition, namely, determining for respective contexts, which applications and/or device resources should NOT (need not) be in a power consuming operational mode for respective contexts where the respective contexts are discovered through automated determining (tracking) of the specific application usage patterns (AUP's) and the specific resource usage patterns (RUP's) of the individual users and of their respective specific client devices. Then the unnecessary applications and/or device resources can be responsively placed into sleep or shut off modes based on automated detection of the respective current contexts of respective individual users.

There are three stages in the process of optimizing based on detection of specific contexts: (1) first automatically collecting useful metadata that is indicative of context and of application usage patterns (AUP's) and resource usage patterns (RUP's) of individual users and of their respective specific client devices; (2) second, after substantially centralizing the collected data, using automated machine learning to discover and classify the device usage characteristics for various devices (or device classes) and/or of device usage characteristics for various users (or user classes) where this learning can include identifying and categorizing respective device classes and/or user classes and consequences of the same to power consumption and quality of service in the respective devices; and (3) third, at appropriate times, tuning (or replacing) the power management controllers (e.g., governors) running on each specific device (or for each specific class of mobile devices) based on the learned usage patterns and consequences thereof so that unnecessary causes of power consumption within the classified contexts are turned off or reduced.

There are however problems with collecting the usage metadata on an individualized basis, one user at a time. Not all users use their respective devices all the time and then when they do employ the device, they may not always use each and every application each time. So a system that collects usage metadata on an individualized basis may have to wait a very long time before a statistically significant amount of usage data is collected for a given individual user. The user may change phones (or that of mobile device) by that time, or may change applications used, or the operating system (OS) version and/or other supervisory firmware/software may change. The metadata that has been collected on an individualized basis may then become obsolete.

In accordance with one aspect of the present disclosure, users are categorized into groups of users who use substantially same or similar mobile devices and into subgroups of those who use substantially same or similar applications in substantially same or similar contexts. The collected metadata of the subgroups are sorted in the cloud (or within the storage resources of another appropriate data collecting and centralizing entity) and aggregated according to categorized groups or subgroups to define crowd-sourced collected metadata whereby representative usage pattern data is collected much faster than if the system had to wait to collect on an individualized basis, statistically significant amount of usage data for each individual user from his/her respective one or more personal mobile devices. Then based on the analysis results of the crowd-sourced collected metadata, corresponding refinements to, or replacements of the power management policies of respective mobile devices are downloaded to the members of the respective subgroups, even if some members of each defined subgroup did not participate in providing the upload data about their respective application usage patterns (AUP's), resource usage patterns (RUP's), energy consumption or power consumption patterns and corresponding qualities of service (QoS's). In one embodiment, the power management policy rules or refinements thereof that are downloaded to each individual mobile device are only those necessary for the application usage patterns (AUP's) of that one mobile device.

Data Collection and Associated Machine Learning

As mentioned above, collectable metadata can uniquely vary with each device due to differing usage patterns from person to person. Additionally, the internal hardware itself might be different from one mobile device to the next (e.g., in terms of heat dissipation characteristics, display power consumption characteristics, analog transmitter characteristics, etc.). Different models of a same brand may have very different hardware and correspondingly different performance and energy consumption characteristics.

In accordance with one aspect of the present disclosure, performance tracking applications (and/or firmware and/or software patches) are installed on the mobile devices to collect usage statistics to the extent possible with the specific mobile devices and the OS's and consumer applications run on them, preferably under different operating conditions such as for example at different geographic locations, at different times of the day, under different weather conditions and/or under different other contexts. With such additional software support installed, the consumer applications that are running within each context (e.g., time of day, location, etc.) are profiled to collect their specific performance information in the specific mobile devices and within the respective contexts. When a new mobile device is purchased by an end user, that new mobile device and each of its end users is allocated corresponding cloud storage space (e.g., in a database) where all the collected metadata for that new (instrumented) mobile device and its one or more end users may be stored. A machine learning algorithm runs in the cloud and learns over time from automatically and repeatedly uploaded information about how the instrumented mobile device performs (in terms of power consumption and QoS) in different geographic locations, at different times of the day and/or for other contextual states while running different end user applications. The machine learning algorithm periodically updates a set of parameters unique to the instrumented mobile device and its respective one or more users. Adaptive expert rules are automatically developed and stored in a database for correlating context with application usage patterns (AUP's) and resource usage patterns (RUP's). As an example, the collected metadata fed into the Machine Learning algorithm can be used to develop expert rules that predict the times in the day for specific locations when a first particular application will be used the most often while one or more other applications are not used or needed. This usage pattern information can then be used to automatically determine when and which other applications should be automatically turned off or put into idle mode while the most likely one or few power-consuming applications run within the given context. Usage pattern data can thus be analyzed and later used to reduce power consumption based on time and/or location or other user context.

The Power Management Controller

The power management controller dynamically adjusts system power management configurations (DVFS being one of a number of possible such configurations for managing power) while specific applications are running on the specific mobile device within a relevant context (e.g., time of day, location, user context). The objective of the controller is to dynamically maintain a user acceptable performance (e.g., QoS) for each of user-utilized currently-running applications while simultaneously minimizing power and/or energy consumption. In one embodiment, each end user specifies acceptable performance targets for one or more of the end user applications (or classes of such applications) under corresponding contexts and the controller accordingly dynamically chooses system settings (e.g., the utilized Vdd voltage and frequency f pair controlled by each respective governor) to thereby reduce or minimize energy consumption while still providing the desired or acceptable QoS for the specific applications. Lower energy and/or power consumption generally translates into longer battery life.

The power management controller(s) of each class of device may be different and may require data specific to the specific device (e.g., an aged device) for dynamically optimizing power consumption in that specific device. For example, as shown in Table 1A, for a given first application (App1) running on a specific client device and using two governed circuit resources, each governor having a respectively selected configuration at a given moment in time, there is associated an average performance rating (QoS—determined by appropriate proxy metrics) and an average power consumption for that configuration (also determined by appropriate proxy metrics). Typically, the dynamically set configurations of the power management controller(s) is/are locally adjusted in accordance with a downloaded policy once per second or even at a more frequent rate (e.g., once every few milliseconds). Although the exemplary power management controller of Table 1A is illustrated as having two governors (Gov_1 and Gov_2), more generally power management controllers are not limited to a specific number of governors and typically the power management controllers will have further parts such as a cache tuning part, a memory compression/decompression control part and so on. Each part can have its own respective configuration for a given local update phase. Additionally, the example values given for QoS and power consumption may not be representative of typically collected profiling data. In other examples (not shown), each respective row may have a respective different QoS value and respective different power consumption value. Although the below Tables 1A and 1B are depicted as having a small number of rows and columns, it is within the contemplation of the disclosure to have larger and/or more complex characterization tables for different applications run one at a time or in simultaneous combinations or even for different execution phases (states) of each application. See for example Table 1C below 1A and 1B.

TABLE 1A
Profiling data for application App1

| | Controller | | QoS | Power Consumed by |
|---|---|---|---|---|
| Row | parts | V/f Config | of App1 | Governed Resources |
| 1 | Gov_1: | Config_1 | Q_1 | Pwr_1 |
| | Gov_2: | Config_0 | | |
| 2 | Gov_1 | Config_2 | Q_2 | Pwr_1 |
| | Gov_2: | Config_0 | | |
| 3 | Gov_1 | Config_3 | Q_1 | Pwr_2 |
| | Gov_2: | Config_0 | | |
| 4 | Gov_1: | Config_0 | Q_3 | Pwr_3 |
| | Gov_2: | Config_4 | | |
| 5 | Gov_1 | Config_0 | Q_2 | Pwr_4 |
| | Gov_2: | Config_5 | | |
| 6 | Gov_1 | Config_0 | Q_4 | Pwr_5 |
| | Gov_2: | Config_6 | | |
| . . . | . . . | . . . | . . . | . . . |

As shown in Table 1B, for a given second application (App2) running on the same specific client device and using the two governed circuit resources, there can be associated different average performance rating (QoS) and average power consumptions for those configurations. In other words, each application may exhibit different behaviors.

TABLE 1B
Profiling data for application App2

| | Controller | | QoS | Power Consumed by |
|---|---|---|---|---|
| Row | parts | V/f Config | of App2 | Governed Resources |
| 1 | Gov_1: | Config_1 | Q_3 | Pwr_3 |
| | Gov_2: | Config_0 | | |
| 2 | Gov_1 | Config_2 | Q_2 | Pwr_2 |
| | Gov_2: | Config_0 | | |
| 3 | Gov_1 | Config_3 | Q_1 | Pwr_1 |
| | Gov_2: | Config_0 | | |
| 4 | Gov_1: | Config_0 | Q_1 | Pwr_5 |
| | Gov_2: | Config_4 | | |
| 5 | Gov_1 | Config_0 | Q_3 | Pwr_3 |
| | Gov_2: | Config_5 | | |
| 6 | Gov_1 | Config_0 | Q_4 | Pwr_1 |
| | Gov_2: | Config_6 | | |
| . . . | . . . | . . . | . . . | . . . |

The QoS and consumed power (or consumed energy) metrics of Tables 1A and 1B may come in forms other than single quantitative or qualitative indicators. For example, QoS may have several separate factors included before computation reduces it to a single indicator. Similarly, consumed power/energy may have several separate factors included before computation reduces it to a single indicator. In one embodiment, the local specific client device uploads its raw, pre-computation data to the cloud and all computations are then carried out in the cloud. In other embodiments, the local specific client device may perform some of the computations (e.g., data averaging) locally and then upload partial results to the cloud where further computations are then carried out. The goal is to minimize energy consumption overhead due to local computations and transmissions that support the performance tracking function.

TABLE 1C
Profiling data for application App3

| | | | QoS | |
|---|---|---|---|---|
| | | | of App3 | Power Consumed by |
| | | | when in | Controlled Resources |
| | Controller | | exec | when App3 is in execution |
| Row | parts | Config | state s: | state s: |
| 1 | Gov_1: | Config_1 | s1: Q_3 | s1: Pwr_3 |
| | Cache_2: | Config_0 | s2: Q_4 | s2: Pwr_1 |
| 2 | Gov_1 | Config_2 | s1: Q_1 | s1: Pwr_1 |
| | Cache_2: | Config_0 | s2: Q_2 | s2: Pwr_2 |
| 3 | Gov_1 | Config_3 | s1: Q_5 | s1: Pwr_5 |
| | Cache_2: | Config_0 | s2: Q_4 | s2: Pwr_1 |
| 4 | Gov_1: | Config_0 | s1: Q_0 | s1: Pwr_1 |
| | Cache_2: | Config_4 | s2: Q_3 | s2: Pwr_2 |
| 5 | Gov_1 | Config_0 | s1: Q_3 | s1: Pwr_2 |
| | Cache_2: | Config_5 | s2: Q_4 | s2: Pwr_4 |
| 6 | Gov_1 | Config_0 | s1: Q_3 | s1: Pwr_1 |
| | Cache_2: | Config_6 | s2: Q_4 | s2: Pwr_5 |
| . . . | . . . | . . . | . . . | . . . |

As seen in Table 1C, the policy-configured parts of the dynamic system power management controller need not be just V/f setting governors. An automated cache tuner (as an example) can also participate. Also as seen in Table 1C, the performance parameters need not be limited to total (summed over time) performance of each application and instead separate parameters for indicating QoS and indicating power and/or energy consumption may be collected for different execution states or phases of each application.

When the device is shipped, device specific configuration policy plans for use by the dynamic power management controller (e.g., by governors G_1 and G_2 and/or cache tuner Cache_2) is set to default parameters. However, once an end user starts using the device, metadata (e.g., raw data or partially compressed data) starts to get automatically collected, uploaded and stored in the cloud. Machine learning commences once a predetermined critical amount of the uploaded data has been collected and device specific, new controller optimizing policy plan get generated. The controller optimizing policy plans or deltas representing them may be then downloaded to the specific client device as Over-The-Air (OTA) update data. The updated controller with new (better) configuration rules implements the updated configuration policy plan(s). In one embodiment, the updated configuration policy plan(s) automatically change strategies in response to detection of corresponding contexts where the respective changes are warranted. The contexts which invoke change can be time based, location based, application run time based (how many and which other applications are being run) and/or otherwise. The controller can be designed in multiple ways to respond to determined local context, such as (i) A single strategy for the entire device (similar to the default governor settings irrespective of which one or more applications are running) and (ii) Application Specific strategy which takes into account how many and which specific applications are being run with what priority weights. Controller policy plans in both cases can be periodically updated within the cloud. In one embodiment, the cloud collects about a week's worth of performance tracking data, determines the average application usage patterns (AUP's) and average resource usage patterns (RUP's) for the specific client device based on the week's worth of performance tracking data and generates a corresponding policy plan accordingly. If the end user requests a change in the controller policy at an earlier date, a new controller (or deltas thereto) is simply sent as an update to the mobile device.

Referring to FIG. 2A, shown is a timeline example 200 of possible user application utilization patterns (AUP's) and corresponding resource utilization patterns (RUP's) for a specific user (U1) through three exemplary portions of a normal work day, the portions denoted by a first time range 201, a second time range 202 and a third time range 203.

As depicted in FIG. 2A, during the first time range 201 the corresponding user U1 on average (e.g., over a normal work week) is typically located at a first geographic location LocU1a, has additional user context attributes denoted as Context_a and has a first set of installed applications (e.g., 211, 212) running on a specific client device (210a) while others of the installed applications (e.g., 213, 214) are idle or turned off.

Over the week's time and for this first time range 201 that is specific to the first user U1, metadata is uploaded to the cloud to reveal a corresponding set of utilization patterns 231. The metadata-based patterns 231 are partitioned into a user's application usage pattern set (AUP1) and a device resources usage pattern set (RUP1). For sake of avoiding illustrative clutter, more detailed aspects of the uploaded data such as those indicating quality of service (QoS) for each of the applications and energy or power consumption by each of the resources is not shown. As seen under the exemplary first set of utilization patterns 231, during the first time range 201 the first user tends to use App1 at a relatively high rate, App2 at a lower rate and generally does not use App3 at all. Also for the given user location LocU1a and/or other user context attributes Context_a, a first resource of the specific client device (210a), namely, CPU1 on average runs at a medium rate while a second resource (WiFi) operates at a higher rate, a third resource (Display) also runs at a higher rate and a fourth identified resource (Camera) is generally not used.

As further depicted in FIG. 2A, during the second time range 202 the corresponding user U1 on average (e.g., over a normal work week) is typically located at a second geographic location LocU1b, has additional user context attributes denoted as Context_b and has a second set of installed applications (e.g., 215, 216) running on the same specific client device (210a′; primed because it is in another state) while others of the installed applications (e.g., 217, 218) are idle or turned off.

Over the same week's time and for the second time range 202 (e.g., lunch hour) that is specific to the first user U1, further metadata is uploaded to the cloud to reveal a corresponding second set of utilization patterns 232. The second set of metadata-based patterns 232 are partitioned into a user's application usage pattern set (AUP2) and a device resources usage pattern set (RUP2). As seen within the exemplary second set of utilization patterns 232, during the second time range 202 the first user tends to not use App1, to use App4 at a medium rate and to use App3 at a high rate. Also for the given user location LocU1b and/or other user context attributes Context_b (e.g., driving in car to/from lunch place), the first resource of the specific client device (210a′), namely, CPU1 on average runs at a high rate while the second resource (WiFi) does not operate, the third resource (Display) runs at a medium rate and the fourth identified resource (Camera) is generally not used.

As yet further depicted in FIG. 2A, during the third time range 203 the corresponding user U1 on average (e.g., over a normal work week) is typically located at a third geographic location LocU1c, has additional user context attributes denoted as Context_c and has a third set of installed applications (e.g., 221, 222) running on the same specific client device (210a″; double primed because it is in yet another state) while others of the installed applications (e.g., 223, 224) are idle or turned off.

Over the same week's time but for the third time range 203 (e.g., after lunch hour) that is specific to the first user U1, further metadata is uploaded to the cloud to reveal a corresponding third set of utilization patterns 233. The third set of metadata-based patterns 233 are partitioned into a user's application usage pattern set (AUP3) and a device resources usage pattern set (RUP3) corresponding to the third time range 203. As seen within the exemplary third set of utilization patterns 233, during the third time range 203 the first user tends to use App1 at a relatively medium rate, to use App2 at a high rate and to use an App5 also at a high rate. Also for the given user location LocU1c and/or other user context attributes Context_c (e.g., after lunch), the first resource of the specific client device (210a′), namely, CPU1 on average runs at a high rate, the second resource (WiFi) operates at a high rate, the third resource (Display) runs at a high rate and the fourth identified resource (Camera) additionally operates at a high rate.

Given the identified utilization patterns sets 231, 232, 233 derived from the metadata uploaded to the cloud during respective time ranges 201, 202, 203; the artificial intelligence data processing resources within the cloud (e.g., 13n of FIG. 1) can generate corresponding time-based and/or other context-based power management policies to be locally used by the specific client device 210a for minimizing power and/or energy drainage by the identified specific resources for the respectively identified utilization patterns sets 231, 232, 233. Of importance, the generated power management policies are specific to the specific user device 210a and optionally specific to the normal states of that specific user device when corresponding specific sets of applications (as identified by the AUP's) are executing within the corresponding locations and/or under others of the corresponding contexts (e.g., before, during and after lunch). Moreover, the generated power management policies can be specific to the specific resource utilization patterns of the specific user device 210a when operating with a specific one or a combination of two or more specific applications. As a result, the generated power management policies can be more finely tuned to cooperatively work with the specific ones of the utilized applications and the specific ones of the utilized resources of the specific client device 210a. They are not device and/or application agnostic.

Referring to FIG. 2B, shown is a schematic illustrating a crowd sourcing embodiment 250. Here usage pattern data is automatically collected from one or more relatively large pools of volunteers (e.g., U1′, U2′, Un′) for each specific brand/version of mobile devices and/or for each specific class of mobile devices that operate similarly. Since usage pattern data (e.g., AUP's, RUP's) is being collected (for example, in pre-specified data collection periods, e.g., every hour, every 3 hours, every day, etc.) from a relatively large pool of similarly situated users (e.g., those at location LocUxa), statistically significant usage data may be collected faster for categorized groups of mobile devices and correspondingly categorized groups and subgroups of users and then used for providing quicker updates than would be possible if based on data collected on an individualized basis for each user. More specifically, a first group of users 251 referred to as Crowd-A is depicted as sharing a first geographic region denoted as LocUXa and/or sharing first other context attributes denoted as UserX_Context_a during a pre-specified time period which includes a first user's usage period 251a1 and which includes at least one other user's usage period e.g., 251an. Here, the General Form Usage Period Reference Designation 251Ym corresponds to a context named Y and/or a location named LocY and a user named Um′ where m′ is an identifier between 1′ and n′ inclusive for users U1′ through Un′ of Crowd-A. It is to be understood that in one embodiment, geographic location and time of day are not considered core data needed for categorizing devices, resource usage patterns (RUP's) and application usage patterns (AUP's) and instead the core metadata may consist for example only of: the device IMEI and device model identification for identifying each device and its hardware category; the current OS version for identifying each device according to a respective supervisory software category; the ID and version number of the currently running application for identifying each device according to its respective application software category; the core resource usage pattern (RUP) in terms of CPU frequency, memory bandwidth and GPU frequency for identifying each device according to its respective current resources configuration and the current power consumption by each of the core resources (e.g., CPU, memory, GPU). Other factors (e.g., location, time, temperature, humidity) may be considered as secondary.

The mobile devices, 210a1 through 210an that are respectively used by users U1′ through Un′ of Crowd-A in the first geographic region denoted as LocUXa and/or while sharing the other first context attributes denoted as UserX_Context_a and during the pre-specified time period which includes user usage periods 251a1-251an are understood to be substantially the same and/or belonging to a substantially same class of such mobile devices due to at least commonality with respect to at least one of: (1) brand of device; (2) version number of the device; (3) operating system used by the device; (4) hardware resources used within the device; and (5) at least a specific one if not a specific set of foreground applications running in the device. The respective usage patterns (e.g., AUP's, RUP's) 231a-233a of respective users U1′ through Un′ of Crowd-A during the pre-specified time period are automatically uploaded from the respective mobile devices 210a1 through 210an to the cloud 230 for accumulation therein and analysis once a sufficient amount of usage pattern data has been collected to provide statistically significant analysis results.

In similar vein, a second group of users 252 referred to as Crowd-B is depicted as sharing a second geographic region denoted as LocUXb and/or sharing first other context attributes denoted as UserX_Context_b during a pre-specified time period which includes a corresponding first user's usage period 252b1 and which includes at least one other user's usage period e.g., 252bn. Where here, the user names are in the form Um″ where m″ is an identifier between 1″ and n″ inclusive for users U1″ through Un″ of Crowd-B.

The mobile devices, 210b1 through 210bn that are respectively used by users U1″ through Un″ of Crowd-B in the second geographic region denoted as LocUXb and/or while sharing the other second context attributes denoted as UserX_Context_b and during the pre-specified time period which includes user usage periods 252b1-252bn are understood to be substantially the same and/or belonging to a substantially same class of such mobile devices due to at least commonality with respect to at least one of: (1) brand of device (e.g., Android™, Apple™, Samsung™, etc.); (2) version number of the device (e.g., iPhone5™, iPhone6™, iPhone7™ etc.); (3) operating system used by the device (e.g., iOS9, iOS10), (4) hardware resources used within the device (e.g., specific CPU's, GPU's etc.); and (5) at least a specific one if not a specific set of foreground applications (e.g., 211, 212 of FIG. 2A) running in the device. The respective usage patterns (e.g., AUP's, RUP's) 231b-233b of respective users U1″ through Un″ of Crowd-B during the corresponding pre-specified time period are automatically uploaded from the respective mobile devices 210b1 through 210bn to the cloud 230 for accumulation therein and analysis once a sufficient amount of usage pattern data has been collected to provide statistically significant analysis results.

For sake of showing continuance of the pattern, FIG. 2B additionally depicts a third group of users 253 referred to as Crowd-C having users U1′″ through Un′″ possessing corresponding active mobile devices 210c1 through 210cn in the third geographic region denoted as LocUXc and/or while sharing the other second context attributes denoted as UserX_Context_c and during the pre-specified time period which includes user usage periods 253c1-253cn where those mobile devices are understood to be substantially the same and/or belonging to a substantially same class of such mobile devices. The respective usage patterns (e.g., AUP's, RUP's) 231c-233c (latter not shown) are automatically uploaded from the respective mobile devices 210c1 through 210cn to the cloud 230 for accumulation therein and analysis once a sufficient amount of usage pattern data has been collected to provide statistically significant analysis results. It is to be understood that yet further respective usage patterns 233x of yet other crowds are similarly uploaded, accumulated and analyzed once sufficient amounts of respective usage pattern data have been collected to provide statistically significant analysis results. The analysis results will indicate whether optimal usage patterns are being currently obtained for providing the respective foreground applications with the desired or acceptable QoS's while at the same time minimizing power and/or energy consumption so as to maximize battery life.

The analysis results may include a determination of the better power management policies for increasing the respective QoS's and/or reducing the power and/or energy consumption's so as to improve battery longevity between charges. If such better power management policies are developed, they are downloaded to the respective user devices so as to provide better performance. It is to be understood that since data is being collected in parallel from the users of each crowd (e.g., Crowd-A, Crowd-B, etc.), the desired sufficient amount of statistically significant data will be collected faster as the size of each respective crowd grows. Then the analysis results and improved power management policies can be developed and fed back to the respective crowds in correspondingly faster times. In accordance with one embodiment of the present disclosure, crowds with smaller number of participants are identified, additional users who may join the crowds are identified and requests are automatically sent to those identified additional users imploring them to join as volunteers in order to help with the common cause of more quickly gathering statistically significant for information and then more quickly providing iterative improvements to the power management policies in view of monitored usage patterns.

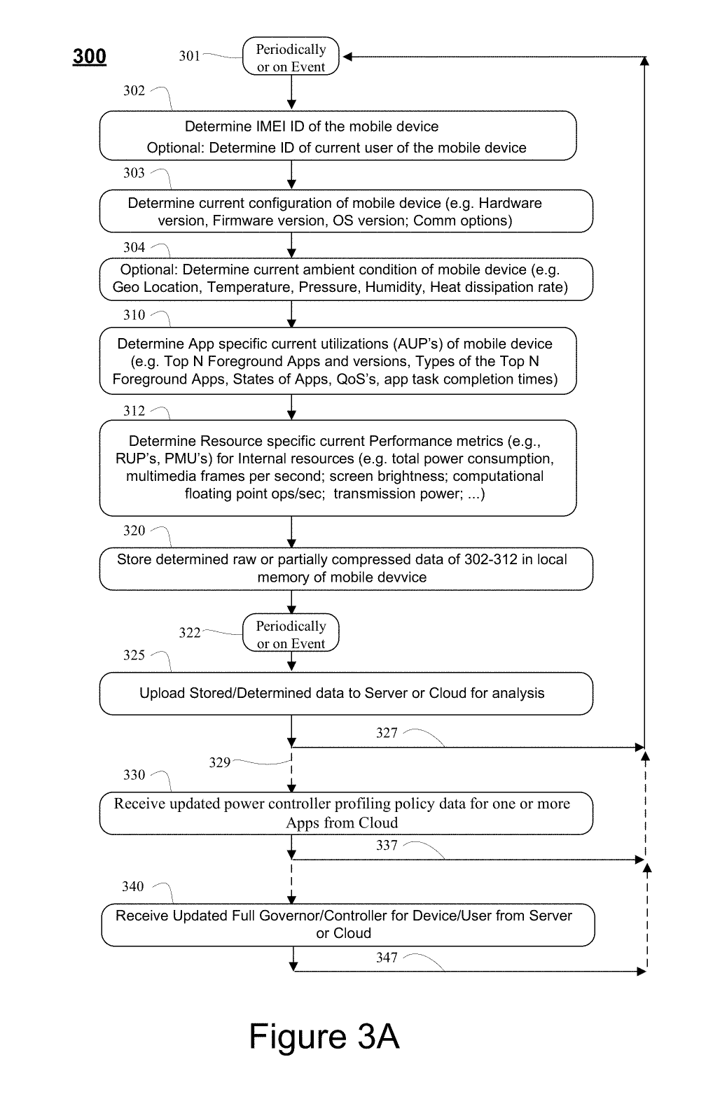

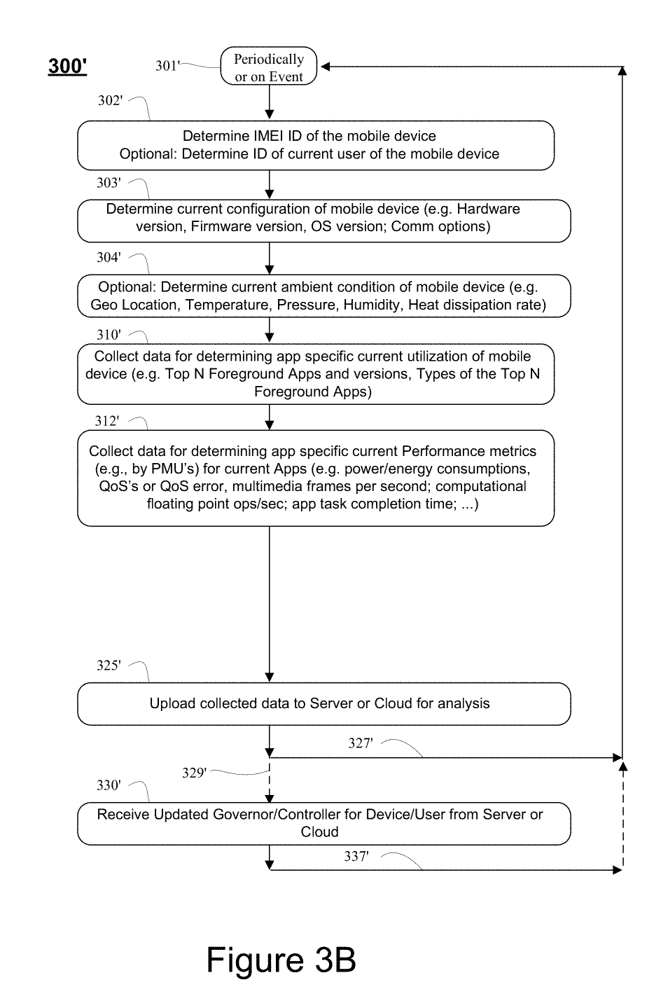

Referring to FIG. 3A, shown is a flow chart for a first machine implemented automatic process 300 carried out in each instrumented mobile device. Entry may be made periodically or on pre-specified events at step 301.

At step 302 the specific mobile device is identified by a unique identification indicator. In one embodiment this includes obtaining the International Mobile Equipment Identity (IMEI) number of the device. Alternate or additional identification methods may be used. Optionally within step 302 a unique identifier for the current user of the specific mobile device is also obtained. This may be useful when multiple users utilize a same specific mobile device for example at different times of the day.

At step 303 a determination is made of the current hardware and software resources of the specific mobile device. This may include obtaining hardware version numbers, firmware version numbers, operating system version numbers and communication resources version numbers.

At step 304 a determination is made of current ambient conditions of the specific mobile device. This step may include using GPS or other geographic location determining mechanisms for determining the current location of the mobile device. The step may additionally or alternatively include determining at least a current ambient temperature of the device and optionally operating temperatures of specific chips or other components within the device. The step may further include measuring air pressure and humidity and/or current heat dissipation rates of the device. Such ambient condition determinations may be useful for determining maximum power levels at which the device may currently be safely operated.

At step 310 a determination is made of the current application specific utilizations (AUP's) of the specific mobile device. Examples of such determinations may include determining which are the top N foreground applications running in the device where N is a small integer such as between one and 10 inclusive. Additionally or alternatively a determination can be made of the types or classifications of the top N foreground applications now running in the device. Optionally, determinations may be made of the respective states or phases of the currently executing top N foreground applications; for example, starting up, shutting down, in intense activity state and in sub-intense activity state. Additional information collected for the current top N foreground applications may include the current qualities of service (QoS's) respectively provided by those applications and application task completion times.

At step 312 a determination is made of the current resource specific utilizations (RUP's) of the specific internal resources within the mobile device. In one embodiment the resource utilizations are reported in terms of normalized parameter metric units through use of a Performance Monitoring Unit (PMU) that automatically converts locally measured performance measures into normalized parameter metric units (npmu's) based on pre-specified standards. The determined resource utilizations should include those from which current power and/or energy consumption can be computed or otherwise determined for the respective resource and/or for the mobile device taken in whole. Examples of utilization information may include display utilization information such as multimedia frames per second and screen brightness. Another example of utilization information is that related to current CPU utilization, for example reported in terms of computational floating point operations per second. Another example of utilization information is that related to current analog radio transmission power which could be reported in terms of activity levels or milliWatts per transmitter (or energy consumed per recent transmission). The specific RUP's provided by each specific mobile device may vary depending on the internal resources of that device and the portions that can be instrumented to report their corresponding parameters. Since each specific mobile device can have different parameters, it is left up to the receiving cloud resources to determine how to interpret the uploaded parameters based on the mobile devices IMEI and/or other such unique identifier. In one embodiment, the PMU automatically repeatedly determines error between actual and desired or required QoS metrics in respective pre-determined durations of time. The error amount may be an integration of instantaneous error over time during each predetermined duration. The goal of the system is to minimize error while at the same time also minimizing energy and/or power consumption.

At step 320 the parameters determined in steps 302 through 312 are stored in a local buffer of the specific mobile device. It is within the contemplation of the present disclosure that the information of steps 302 through 312 is collected opportunistically as time allows and placed into the buffer for keeping until a predetermined sufficient amount of such information is collected before uploading to the cloud. Additionally or alternatively, after predetermined sufficient amounts of such information are collected into the buffer, compression of the collected information is carried out locally by the mobile device so that transmission time and power consumption for such transmission is reduced when uploading to the cloud. Compression may include determining averages or medians for the collected raw information.

Step 322 represents waiting for an opportunistic time when best to upload the collected information while not increasing the power consumption of the local mobile device and/or not overwhelming the targeted in-cloud server (13n) with additional data at a time that the server is simultaneously receiving information from a large number of other mobile devices. The transmission time can be scheduled or triggered by a predetermined event such as an information poll request from the in-cloud server.

At step 325 the stored raw or partially compressed information is uploaded to a predesignated server or a predesignated part of the cloud for further analysis. Control normally returns by way of path 327 to step 301 for further automated repetition as conditions allow.

Every so often, but much less frequently than loop 327 is followed, an in-cloud or otherwise located server will push updating policy data to the specific mobile device. This is represented by continuation path 329 and receiving step 330. In step 330 the mobile device receives updated or updating power controller profiling policy data for one or more specific applications installed in that device. In one embodiment, the updating policy information may be in the form of delta values rather than absolute values so as to minimize the time needed for transmitting the updating information. The receiving mobile device implements the updated power management policies and then loops back by way of path 337 to step 301.

Every so often, but much less frequently than loop 337 is followed, the in-cloud or otherwise located server will push a complete and revised power management policy to the specific mobile device. This is represented by the dashed continuation path into step 340. In step 340 the mobile device receives the complete updated power controller profiling policy for all its applications. The receiving mobile device implements the full revised power management policy and then loops back by way of path 347 to step 301.

FIG. 3B depicts an alternate embodiment 300′ in which the mobile device does not accumulate collected data into a local buffer and does not perform partial pre-computation on raw data before uploading to the cloud. Of course, identification step 302′ must be first carried out so that any further uploaded information can be coupled with the unique device identification and optionally with a unique user of the device. At step 303′ the current hardware and/or software configurations of the device are determined. This may include hardware resource versions, firmware versions, operating system versions, communication module versions and so on. Step 304′ optionally determines current contextual conditions of the mobile device including but not limited to current geographic location, current temperature, current air pressure, humidity, device heat dissipation and other contextual attributes. At step 310′, the current application utilization pattern (AUP) data is collected. This may include identifying a top N of currently running foreground applications sorted according to CPU utilization, memory utilization and/or network utilization. The specific applications may be identified and/or specific classes into which the applications belong. At step 312′, the current resource utilization patterns (RUP) data is collected. This may include collection by internal performance monitoring units (PMU's) of resource utilization data associated with the currently executing specific applications. The RUP data may include current power or energy consumption on a per application basis or collective basis. Additional collected information may include actual QoS metrics and/or error between actual QoS and desired or required QoS. Other data that may serve as a proxy for quality of service and/or for current power consumption may include current number of multimedia frames per second, number of CPU floating point operations per second, application task completion times and so on.

At step 325′, the collected data is uploaded to a server or to the cloud for further analysis. It is to be understood that the uploading of the data need not occur collectively in just step 325′. Instead uploading may occur as packets each having the device IMEI ID and AUP or RUP data as currently available at that time. The loop then normally returns by way of path 327′ to step 301′ for repetition in response to a predetermined repeat rate and/or in response to occurrence of one or more predetermined events.

Advancement (329′) to step 330′ occurs less frequently than monitoring loop 327′. In one embodiment, the advancement 329′ occurs about once per week or once per month while of the monitoring loop 327′ occurs one or more times per day. In step 330′, the mobile device receives from the cloud or an appropriate server, one or more updated policies for the power/energy controller. These downloaded policies may include those for one or more identified governors of the mobile device where the update is based on analysis of the usage patterns data uploaded in step 325′. In the case where crowdsourcing is used, the updated power/energy controller policies may be based on analysis of uploaded data from a plurality of users in the crowd that the current mobile device belongs to. Step 330′ may include receipt of completely new power/energy controller code as opposed to merely updated specific controller policies. After the update is verified and instantiated, return path 337′ is taken back to step 301′.

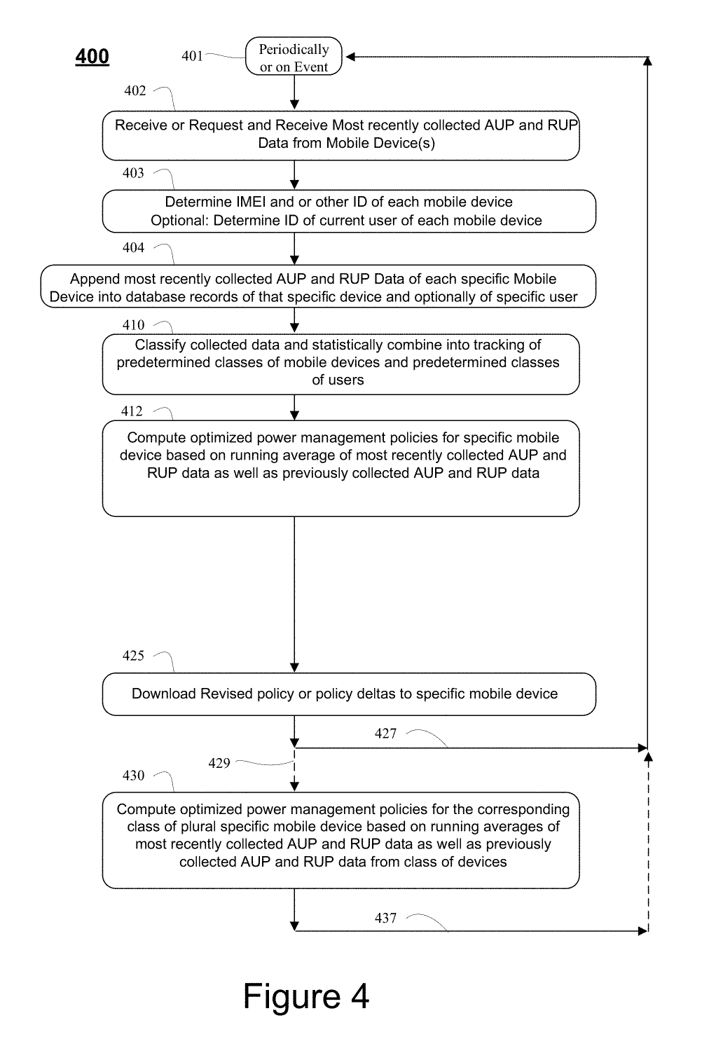

Referring to FIG. 4, shown is a process 400 that may occur in one or more servers remote from the mobile devices and/or in the cloud. Entry is made periodically or upon occurrence of one or more predetermined events at step 401. At step 402, the process 400 receives on a pushed basis or requests on a pull basis, the most recently collected AUP and/or RUP data from a respective one or more mobile devices, for example from a predetermined group of mobile devices belonging to a prespecified crowd.

In step 403 and upon receiving the pushed or pulled information, the process 400 determines the respective unique identification of each device and stores (step 404) the collected AUP and/or RUP data in respect of database records for that identified device. Optionally the collected AUP and/or RUP data is also logically associated with a specific user of the identified device.

Later, in step 410, after it is determined at a statistically sufficient amount of data has been collected for a specific mobile device or for a specific crowd of mobile devices and/or users, the data is analyzed by appropriate artificial intelligence means such as rule-based expert system analysis data processing and the results are sorted and categorized according to specific devices and/or crowds and/or classes of mobile devices. The data may also be categorized and sorted according to specific users and/or classes of users. Categorization of the database records into different classes and/or subclasses of mobile devices and of users may take place with a variety of data analysis tools including, but not limited to, automated pattern recognition and classification and sorting according to the recognized patterns; regression based analysis and curve fitting based analysis.

At step 412 and based on the categorizing and classifying analysis performed in step 410, computations are made for optimized power management policies for specific ones of the mobile devices and/or for specific crowds or classes of mobile devices and/or their classes of users based on historic and more recently received AUP and RUP data for those devices and/or their specific users.

At step 425, and preferably during lull times when communication bandwidth allows and or/respective mobile devices are in idle mode, the corresponding updated power control policies are downloaded to the specific mobile devices and/or crowds of devices or classes of devices or devices of specific classes of users. Then path 427 is taken back to step 401 for repetition of the loop. In one embodiment, rather than automatically updating power control policies, a request is first sent to the end user asking if he/she wants to update their power policies now, later or never. If they accept, then the new policy is installed at the user-designated time (and/or place). Alternatively, the user may be asked to accept an end user agreement that volunteers the user for allowing the automatic sending and installing of such OTA updates at system determined times.

More frequently downloaded policy adjustments may occur for shorter periods of recent history. Step 430 represents less frequent (path 429 is taken infrequently) and more comprehensive policy adjustments that are based on longer-term averaged performance data as analyzed by the corresponding server or in-cloud services over a longer period of time. As indicated above, the rate at which performance data is collected from the field can be enhanced by relying on crowdsourcing as opposed to collecting information from just individual mobile devices. After execution of step 430, path 437 is taken back to step 401 for repetition of the loop.

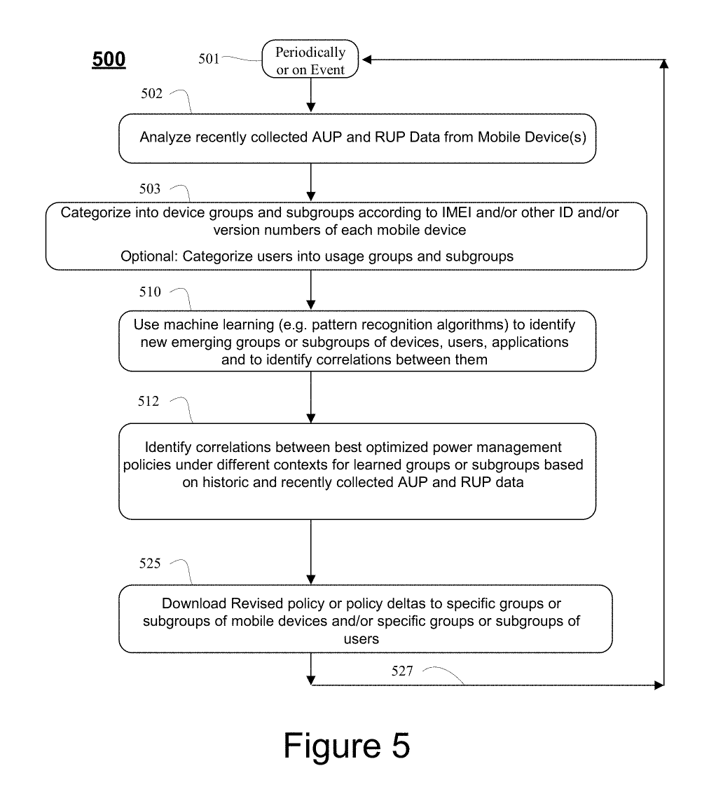

Referring to FIG. 5 a machine analysis process 500 includes periodic and/or event driven entry at step 501. At step 502, the process 500 receives and analyzes recently collected AUP, RUP and QoS versus power consumption data from respectively identified mobile devices of optionally respectively identified users or user classes. At step 503, the process 500 uses the analysis results of step 502 to classify the mobile devices into device groups and subgroups according to one or more of the device brands, model and version numbers, AUP patterns and RUP patterns. Optionally, the process 500 uses the analysis results of step 502 to also classify the users into user groups and subgroups according to one or more of the device brands, model and version numbers, AUP patterns, RUP patterns and user-acceptable QoS versus minimized power consumption patterns.

At step 510, the process 500 compares more recent analysis and classification results against older historic results for the purpose of identifying emerging new trends and new patterns or new correlations. For example new AUP patterns may be determined to be emerging due to release and widespread acceptance by the user population of one or more new mobile apps and/or new operating systems (OS's) or revisions thereof. Furthermore, new RUP patterns may be determined to be emerging due to release and widespread acceptance by the user population of one or more new mobile devices (e.g., new models, new brands). New user groups or subgroups may be determined to be emerging due to migration of some users to the newer software and/or hardware options while others remain with the older versions. Concomitant with machine-implemented automated recognition of the emerging new groups or subgroups, step 510 determines correlations between respective user groups or subgroups and corresponding classes or subclasses of AUP patterns, RUP patterns and/or user-acceptable QoS versus minimized power consumption patterns.

At step 512, the process 500 additionally identifies correlations between the better ones of the possible power management policies and respective usage contexts that the identified users or user groups or subgroups may typically find themselves in for respective ones of the identified classes or subclasses of the mobile devices and for their respectively identified classes or subclasses of AUP patterns, RUP patterns and/or user-acceptable QoS versus minimized power consumption patterns. This identification may be based not only the more recently collected sampling data (e.g., crowd sourced data) but also on age-weighted historical data.

At step 512, the process 500 uses its analysis results to identify currently best power management policies for respective classes or subclasses of the mobile devices and/or for respective groups or subgroups of users and/or for respective usage contexts such as respective classes or subclasses of AUP and of patterns, RUP patterns. Based on these identifications, the process downloads or schedules for download the identified power management policies for respective classes or subclasses of the mobile devices and/or for respective groups or subgroups of users. Path 527 may then be taken back to step 501 for automated repeat of the process 500.

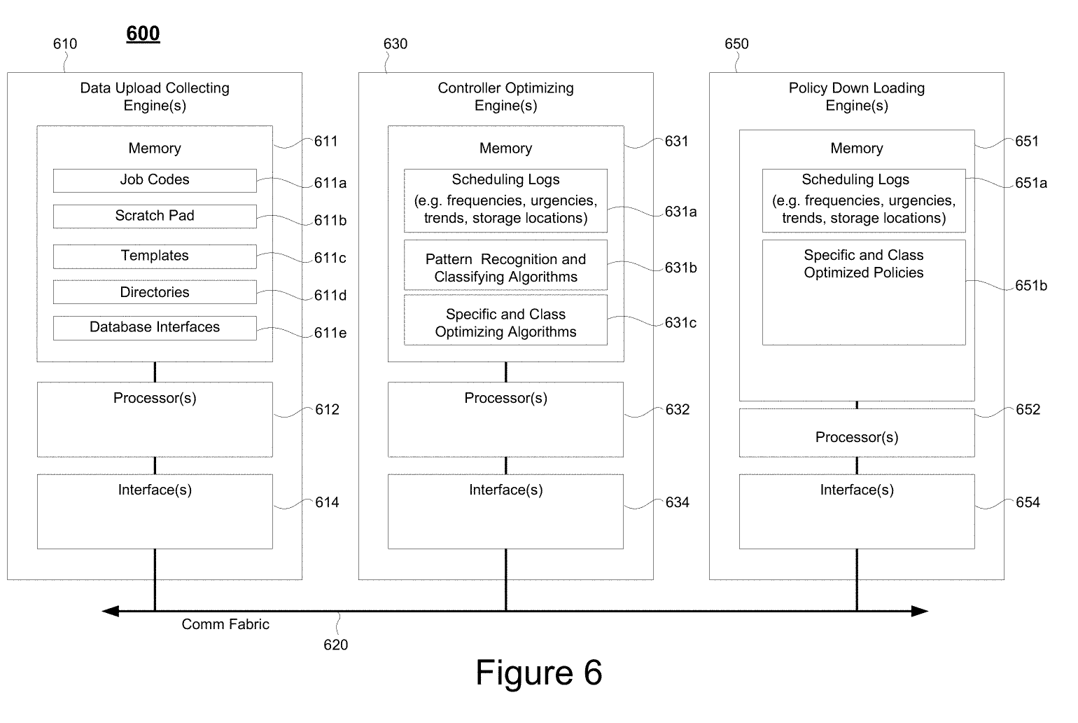

Referring to FIG. 6, shown is a block diagram 600 depicting three types of operatively interconnected automated engines of a system in accordance with the present disclosure. The interconnected engines include one or more sampling data uploading and collecting engines 610, one or more data analysis engines 630, and one or more policy revising download engines 650. The engines 610, 630 and 650 are operatively coupled to one another by way of a common communications fabric 620. The latter fabric may include wireless and/or wired communication resources. Appropriate interfaces 614, 634 and 654 are provided in the respective engines 610, 630 and 650 for communicating by way of the fabric 620. Although not shown, it is to be understood that the communications fabric 620 may extend to operatively communicate with other parts of the partially shown system 600 including one or more expert rules providing and implementing databases or other components of a respective SaaS provider (e.g., 13n, 13m of FIG. 1) or other such data collecting and analyzing entity.

Each of the illustrated engines 610, 630 and 650 includes a respective memory subsystem 611, 631 and 651 configured for storing executable code and data usable by a respective set of one or more processors (612, 632 and 652) of that respective engine. For sake of simplicity and avoiding illustrative clutter, not all the executable codes and in-memory data are shown.

Each sampling data uploading and collecting engine 610 may contain job code 611a loaded by a jobs dispatcher (not shown) into its memory 611. Blank memory space 611b (a.k.a. scratch pad space) may be set aside for computational needs of the dispatched job code 611a. The job code 611a may include machine code and/or higher level code (e.g., SQL code) configured for identifying, fetching and storing desired sampling data into respective database records. Pre-planned data formats or templates may be stored in a memory space 611c allocated for such forms. Directories to different database records (e.g., pre-sorted according to predetermined classes and subclasses) may be stored in a memory space 611d allocated for storing such directories. Specialized interfaces for searching the databases and/or adding data to the databases may be provided in memory area 611e.

After execution of a predetermined number of data collection jobs and/or periodically, the uploaded sampling data of the sampling data uploading and collecting engines 610 are accessed by the one or more data analysis engines 630. The latter engines 630 may contain pattern recognition algorithms, classification algorithms and correlation detecting algorithms 631b configured for identifying groups or subgroups of related objects, classes and subclasses for such objects and correlative relationships there between. In one embodiment, the algorithms readably stored in physical memory 631b may be used for generating performance models and graphs or plots indicating correlations between groups, subgroups and associated QoS performances versus energy consumption metrics. The data analysis engines 630 may further include algorithms 631c for optimizing performance and/or minimizing energy consumption for specific mobile devices and/or classes of such mobile devices. Some data analysis tasks may require prioritization over others due to exigent or emerging trends in the field. Scheduling logs and prioritization algorithms may be provided in area 631a for dealing with such aspects.

The downloading of policy deltas or fully revised power management policies to specific mobile devices, to specific classes or subclasses of mobile devices, to specific users or to specific groups or subgroups of users may be managed in the policy revising download engines 650 by logs and prioritization algorithms provided in area 651a. Already developed policy deltas or fully revised power management policies for specific mobile devices, for specific classes or subclasses of mobile devices, for specific users or for specific groups or subgroups of users may be stored in area 651b. Downloading may be carried out by appropriate data transfer resources (not specifically shown) of the system including communications fabric 620.

Computer-readable non-transitory media described herein may include all types of non-transitory computer readable media, including magnetic storage media, optical storage media, and solid state storage media and specifically excludes transitory signals and mere wires, cables or mere optical fibers that carry them. It should be understood that the software can be installed in and sold with the pre-compute and/or pre-load planning subsystem. Alternatively the software can be obtained and loaded into the pre-compute and/or pre-load planning subsystem, including obtaining the software via a disc medium or from any manner of network or distribution system, including, for example, from a server owned by the software creator or from a server not owned but used by the software creator. The software can be stored on a server for distribution over the Internet, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method carried out in a mobile device for enabling and obtaining device specific refinement or replacement of power management policies of the mobile device, the method comprising:
automatically and repeatedly uploading from the mobile device to a remote service, an identification of the mobile device and at least two of: data indicative of a respective applications usage pattern (AUP) of the mobile device, data indicative of a respective resources usage pattern (RUP) of the mobile device, data indicative of energy and/or power consumption by the mobile device due to at least one of the AUP and the RUP represented by the respectively uploaded and representative data of the AUP and the RUP or data indicative of a quality of service (QoS) provided by mobile device relative to the represented AUP and/or RUP; and
receiving from the remote service a refinement to or replacement of the power management policies of the mobile device, the refinement or replacement being based at least on said automatically and repeatedly uploading from the mobile device to the remote service.

2. The method of claim 1 wherein:
the received refinement or replacement is based also on automatic and repeated uploadings by similarly situated other mobile devices to the data collecting and analyzing entity, the first said mobile device and similarly situated other mobile devices defining a sourcing crowd for the automatic and repeated uploadings.

3. The method of claim 1 wherein:
the remote service is at least partially provided by in-cloud resources of a Software as Service (SaaS) provider.

4. The method of claim 1 wherein the identification of the mobile device includes at least one of:
an International Mobile Equipment Identity (IMEI) number of the mobile device;
an identification of a manufacturer of the mobile device;
an identification of a model line to which the mobile device belongs;
an identification of a version number of the mobile device;
an identification of an operating system of the mobile device;
an identification of hardware resources within the mobile device;
an identification of firmware resources within the mobile device; or
an identification of software resources within or immediately accessible by the mobile device.

5. The method of claim 1 wherein the applications usage pattern (AUP) of the mobile device includes at least one of:
an identification of one or more applications being currently used as foreground executables of the mobile device;
an identification of a predetermined number N of most favored applications used by the mobile device over a pre-specified recent period of time, each of the applications being identified by at least one of title, vendor number, serial number and a group or class of applications to which it belongs;
an identification of an average level of sophistication employed when executing one or more of the identified N most favored applications;
an indication of an average amount of time spent by the mobile device in executing one or more of the identified N most favored applications;
an indication of a respective minimum quality of service acceptable when executing a respective one or more of the identified N most favored applications;
an identification of most likely respective locations and/or respective other contexts when executing a respective one or more of the identified N most favored applications; or
a ranked ordering of the identified N most favored applications based on at least one of: average time the respective application or a subgroup to which it belongs is used, urgency of having the respective application usable even when battery power is low, urgency of having the respective application usable in a pre-specified location and/or other pre-specified context.

6. The method of claim 1 wherein the resources usage pattern (RUP) of the mobile device includes at least one of:
an identification of one or more hardware and/or firmware resources being currently used within the mobile device;
an identification of a predetermined number N of most favored resources used by the mobile device over a pre-specified recent period of time, each of the resources being identified by at least one of type, vendor number, serial number and a group or class of resources to which it belongs;
an identification of an average level of power drawn or frequency and voltage employed when utilizing one or more of the identified N most favored resources;
an indication of an average amount of time spent by the mobile device in utilizing one or more of the identified N most favored resources;
an identification of most likely respective locations and/or respective other contexts when utilizing a respective one or more of the identified N most favored resources; or
a ranked ordering of the identified N most favored resources based on at least one of: average time the respective resource or a subgroup to which it belongs is used, power or energy consumed by the respective resource or by a subgroup to which it belongs, urgency of having the respective resource usable in a pre-specified location and/or other pre-specified context.

7. The method of claim 1 wherein the indicated quality of service (QoS) relates to at least one of:
a level of service provided by one or more of currently executing applications of the mobile device;
a level of service provided by a pre-specified number N of most favored applications used by the mobile device over a pre-specified recent period of time;
a level of service provided by one or more of currently utilized hardware and/or firmware resources of the mobile device; or
a level of service provided by a pre-specified number N of most favored resources used by the mobile device over a pre-specified recent period of time.

8. The method of claim 1 wherein said receiving of a refinement to or replacement of a power management policy of the mobile device comprises:
receiving of a refinement to or replacement of a power management policy for one or more governors of the mobile device.

9. The method of claim 1 wherein said receiving of a refinement to or replacement of a power management policy of the mobile device comprises:
receiving of a refinement to or replacement of a power management policy for a CPU cache tuning controller of the mobile device.

10. The method of claim 1 wherein said receiving of a refinement to or replacement of a power management policy of the mobile device comprises:
receiving of a refinement to or replacement of a power management policy for a dynamic usage controller of a pre-specified hardware or firmware resource of the mobile device.

11. A computer-implemented method for generating energy consumption profiling data, the method comprising:
automatically and repeatedly collecting, from each of a plurality of mobile devices, respective identification of the mobile device and usage pattern data, the collected usage pattern data including at least one of: a device International Mobile Equipment Identity (IMEI), an identification and version number of a currently running application or firmware on the individualized mobile device, a core resource usage pattern (RUP) in terms of at least one of a processor frequency and a memory bandwidth, or a delivered quality of service and a current power or energy consumption by each core resource whose current RUP or delivered quality of service is being collected; and
ordering the collected data in accordance with at least one of: type of device hardware, type of device firmware, type of or specific ones of favorite applications run on the mobile devices, type of applications usage pattern (AUP), type of device user.

12. The method of claim 11 and further comprising:
determining for at least one of the ordering results, an energy consumption minimizing power management policy that provides user acceptable quality of service.

13. The method of claim 12 wherein:
the determining of the energy consumption minimizing power management policy is based on one or more corresponding types of application usage patterns (AUPs).

14. The method of claim 12 wherein:
the determining of the energy consumption minimizing power management policy is based on one or more corresponding types of device hardware.

15. The method of claim 12 wherein:
the determining of the energy consumption minimizing power management policy is based on one or more corresponding types of device firmware.

16. The method of claim 12 wherein:
the determining of the energy consumption minimizing power management policy is based on one or more corresponding types or specific ones of favorite applications.

17. A mobile device comprising:
one or more processors; and
one or more wireless transmitters;
wherein the mobile device is configured to:
automatically and repeatedly upload by way of its one or more wireless transmitters and to a data collecting and analyzing entity, an identification of the mobile device and at least two of: data indicative of a respective applications usage pattern (AUP) of the mobile device, data indicative of a respective resources usage pattern (RUP) of the mobile device, data indicative of energy and/or power consumption by the mobile device due to at least one of the AUP and the RUP represented by the respectively uploaded and representative data of the AUP and the RUP and data indicative of a quality of service (QoS) provided by mobile device relative to the represented AUP and/or RUP.

18. The device of claim 17 wherein the mobile device is further configured to:
to receive by way of one or more wireless receivers thereof a refinement to or replacement of power management policies of the mobile device, the refinement or replacement being based at least on said automatic and repeated uploading from the mobile device to the data collecting and analyzing entity.

19. The device of claim 18 wherein:
the refinement to or replacement includes that of a power management policy for one or more governors of the mobile device.

20. The device of claim 18 wherein:
the refinement to or replacement includes that for a power management policy for a dynamic usage controller of a pre-specified hardware or firmware resource of the mobile device.
